(19) United States
(12) Patent Application Publication
(10) Pub. No.: US 2013/0031389 A1
(43) Pub. Date: Jan. 31, 2013

(54) Computer System with Over-Subscription Mode of Power Supply

(71) Applicants: George Cheng, Taipei (TW); Hank Chuang Chung, Taipei (TW); Yun-Ting Hsu, Taipei (TW); Kuei Huang Liu, Taipei (TW)

(72) Inventors: George Cheng, Taipei (TW); Hank Chuang Chung, Taipei (TW); Yun-Ting Hsu, Taipei (TW); Kuei Huang Liu, Taipei (TW)

(73) Assignee: INTERNATIONAL BUSINESS MACHINES CORPORATION, Armonk, NY (US)

(21) Appl. No.: 13/554,857

(22) Filed: Jul. 20, 2012

(30) Foreign Application Priority Data
Jul. 27, 2011 (TW) 100126539

(51) Int. Cl. G06F 1/32

(52) U.S. Cl. 713/320

(57) ABSTRACT

A computer system with an over-subscription mode of power-supplying device is provided. The computer system includes at least a power-consuming device, at least a power-supplying device, and a power management controller. The at least a power-supplying device supplies power to the at least a power-consuming device. The output power of the at least a power-supplying device has a maximum label value, a safety limitation value higher than the maximum label value, and an over-subscription zone between the maximum label value and the safety limitation value. The power management controller is coupled with the at least a power-supplying device and the at least a power-consuming device that controls the power consumption of the at least a power-consuming device. If the output power exceeds the maximum label value to enter the over-subscription zone, the power management controller will lower the power consumption of the power-consuming device(s).

The present application is claims the benefit of priority from Taiwan Patent Application 100126539, filed on Jul. 27, 2011.

### BACKGROUND OF THE INVENTION

The present invention relates to computer systems, and more particularly, to a computer system capable of controlling power consumption in an over-subscription mode of power supply.

A conventional computer system, such as a personal computer or a high-level server, requires a power supply in order to operate. Examples of power supplies for servers include IBM 60Y0332 675W HE Redundant Power Supply or IBM 46M1057 675W Redundant Power Supply, available from International Business Machines Corporation of Armonk, N.Y..

To cope with the limited capacity of a power supply, the prior art discloses methods for controlling power consumption of a component, for example, in Charles Lefurgy, Xiaorui Wang, and Malcolm Ware, 2008, “Power capping: a prelude to power shifting,” Cluster Computing 11, 2 (June 2008), 183-195, and in Hewlett-Packard Development Company, L. P., “HP Power Capping and HP Dynamic Power Capping for ProLiant servers,” ref no. TC110107T, published in January 2011.

Furthermore, U.S. Patent Application Pub. Nos. 2002/0171398 and 2009/0265564, both by the inventor of the present invention, disclose methods for controlling power consumption of a component.

### BRIEF SUMMARY

The present invention provides a computer system. The output power of a power-supplying device of the computer system has a maximum label value, a safety limitation value higher than the maximum label value, and an over-subscription zone between the maximum label value and the safety limitation value.

The term “maximum label value” of the output power is hereinafter utilized to mean the maximum power provided by a power-supplying device such that the power-supplying device can operate for a long period of time and in a stable manner without causing damage to a hardware component of any system. Manufacturers of commercially available power-supplying devices usually state in the operation manuals thereof the maximum label value. In general, the manufacturers view damage caused by operation with the output power exceeding the maximum label value as a consequence of improper use of products (power-supplying devices), and thus the manufacturers are not liable for pecuniary compensation. For example, the above-mentioned IBM 60Y0332 675W HE Redundant Power Supply and IBM 46M1057 Redundant Power Supply have a maximum label value of 675W.

Furthermore, if the output power of a power-supplying device increases to a preset “safety limitation value,” it will be necessary to protect hardware components against damage by ordering the power-supplying device to enter a protection procedure (such as entering a constant current mode, a hiccup mode, or a shutdown mode) or starting an intrinsic protection mechanism of another power-supplying device. In general, the manufacturers state the safety limitation value in the operation manuals. For example, the IBM 60Y0332 675W HE Redundant Power Supply and IBM 46M1057 Redundant Power Supply mentioned above have a safety limitation value equal to 120% to 130% of the maximum label value. However, the ratio of the “safety limitation value” to “the maximum label value” varies from product-to-product based on design and manufacturing methods. In this regard, the described embodiment is just illustrative.

In an embodiment of the present invention, a power-supplying device of a computer system can operate temporarily in an over-subscription mode in which the power-supplying device is allowed to operate temporarily within an over-subscription zone of its output power while attempting to lower the power consumption of a power-consuming device and restore the output power to below the maximum label value as soon as possible.

By contrast, the prior art (such as U.S. Patent Application Publication No. 2009/0265564) usually teaches controlling the power consumption of a system according to a single maximum label value (or another upper limit value). In addition, as regards the control method of the prior art, power consumption is never permitted to exceed the maximum label value (or another upper limit value) even for just a short period of time.

In an embodiment of the present invention, a computer system comprises at least a power-consuming device, a power-supplying device, and a power management controller. The power-supplying device supplies power to the at least a power-consuming device. The output power of the power-supplying device has a maximum label value, a safety limitation value higher than the maximum label value, and an over-subscription zone between the maximum label value and the safety limitation value. The power management controller is coupled to the power-supplying device and the at least a power-consuming device that controls power consumption of the at least a power-consuming device. In response to the output power exceeding the maximum label value and entering the over-subscription zone, the power management controller lowers the power consumption of the at least a power-consuming device.

Like the output power of the power-supplying device, the output current and the output voltage of the power-supplying device have a “maximum label value” and a “safety limitation value.” Hence, the present invention can also apply the concept of an “over-subscription zone” to output current and output voltage.

In another embodiment of the present invention, a computer system comprises at least a power-consuming device, a power-supplying device, and a power management controller. The power-supplying device supplies power to the at least a power-consuming device. An output current of the power-supplying device has a maximum label value, a safety limitation value higher than the maximum label value, and an over-subscription zone between the maximum label value and the safety limitation value. The power management controller is coupled to the power-supplying device and the at least a power-consuming device that controls power consumption of the at least a power-consuming device. In response to the output current exceeding the maximum label value and entering an over-subscription zone, the power management controller lowers the power consumption of the at least a power-consuming device.

Accordingly, in an embodiment of the present invention, a computer system allows a power-supplying device to operate in an over-subscription zone of an output current while lowering power consumption of at least a power-consuming device and restoring the output current to below the maximum label value as soon as possible.

In another embodiment of the present invention, a computer system comprises at least a power-consuming device, a power-supplying device, and a power management controller. The power-supplying device supplies power to the at least a power-consuming device. An output voltage of the power-supplying device has a maximum label value, a safety limitation value higher than the maximum label value, and an over-subscription zone between the maximum label value and the safety limitation value. The power management controller is coupled to the power-supplying device and the at least a power-consuming device that controls power consumption of the at least a power-consuming device. In response to the output voltage exceeding the maximum label value to enter the over-subscription zone, the power management controller lowers the power consumption of the at least a power-consuming device.

Accordingly, in an embodiment of the present invention, a computer system allows a power-supplying device to operate in an over-subscription zone of an output voltage while lowering power consumption of at least a power-consuming device and restoring the output voltage to below the maximum label value as soon as possible.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE SEVERAL VIEWS OF THE DRAWINGS

In order that the advantages of the invention will be readily understood, a more particular description of the invention briefly described above will be provided by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of the hardware framework of a computer system according to a specific embodiment of the present invention; and

FIG. 2 are graphs of examples of power supply over-subscription according to the present invention.

### DETAILED DESCRIPTION

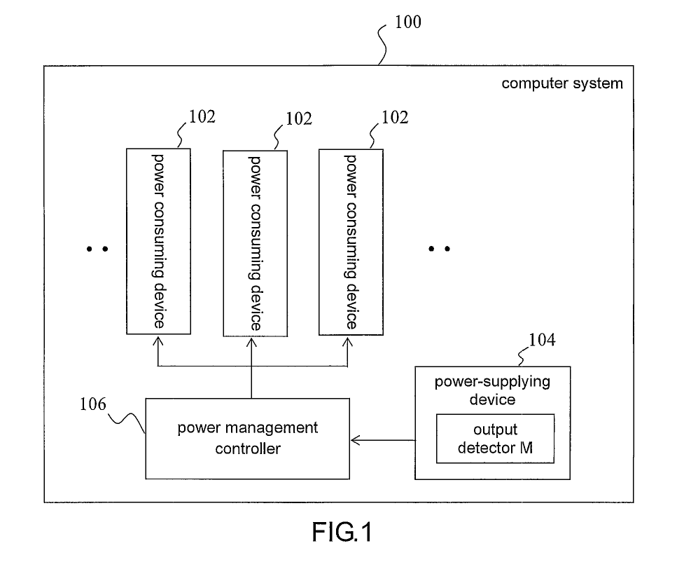

Referring to FIG. 1, there is shown a block diagram of the hardware framework of a computer system 100 according to a specific embodiment of the present invention. The computer system 100 comprises at least a power-consuming device 102, at least a power-supplying device 104, and a power management controller 106.

Examples of the at least a power-consuming device 102 are a processor, a fan, a memory, a PCI device, and a hard disk drive. The at least a power-supplying device 104 supplies direct current (DC) power to the at least a power-consuming device 102. The at least a power-supplying device 104 comprises an output detector M for monitoring the output power, output current, or output voltage of the at least a power-supplying device 104. The at least one power-supplying device 104 can be implemented, for example, as an improvement of the IBM 60Y0332 675W HE Redundant Power Supply or IBM 46M1057 675W Redundant Power Supply mentioned above. The power management controller 106 comprises a microprocessor and a memory (not shown), preferably integrated with a baseboard management controller (BMC) of a motherboard (not shown) of the computer system 100. The technical features which distinguish the at least a power-supplying device 104 and the power management controller 106 from the prior art are described below.

Details which are irrelevant to the present invention are omitted from FIG. 1. For the other basic frameworks and components of the computer system 100, reference can be made to a conventional personal computer or a conventional server, such as System X, Blade Center or eServer server of International Business Machines Corporation or to U.S. Patent Application Publication Nos. 2002/0171398 and 2009/0265564. Related details of the prior art are cited and included hereunder.

### Power-Supplying Device

As regards the at least one power-supplying device 104 shown in FIG. 1, the example below illustrates the present invention by putting forth three different power-supplying devices, that is, the power-supplying devices 104 (A, B, C), whose maximum label values are 900W, 750W, 550W, respectively, but the present invention is not limited thereto. Table 1 enumerates output characteristics of the power-supplying devices 104 (A, B, C). However, persons skilled in the art should understand that, in practice, the output characteristics enumerated in Table 1 are subject to slight changes (e.g., ±5%).

TABLE 1

| | power-supplying device | | | | | |
|---|---|---|---|---|---|---|
| | Type A | | Type B | | Type C | |
| maximum label power | 900 | W | 750 | W | 550 | W |
| safety limitation power | 1200 | W | 990 | W | 730 | W |
| label voltage | +12.2 | V | +12.2 | V | +12.2 | V |
| safety limitation voltage | 13.8 | V | 13.8 | V | 13.8 | V |
| maximum label current | 73.8 | A | 61.5 | A | 45.1 | A |
| safety limitation current | 98 | A | 81 | A | 60 | A |

### First Embodiment

### Output Power

In this embodiment, as shown in Table 1, the output power of the power-supplying devices 104 (A, B, C) is defined with a “maximum label power” and a “safety limitation power” whose definitions are similar to those of the aforesaid “the maximum label value” and “safety limitation value.” Hence, the output power of the power-supplying devices 104 (A, B, C) (hereinafter referred to as the power-supplying devices 104) is always designed to enable the power-supplying devices 104 to operate in an “over-subscription zone” for a short period of time.

Referring to FIG. 1, in this embodiment, during the operation of the computer system 100, the power management controller 106 configures the power consumption of the at least one power-consuming device 102 in a manner that the output power of the power-supplying devices 104 does not exceed the “maximum label power.” However, inevitably, in case of an emergency (for example, when other collaborating power-supplying devices are suddenly removed or break down), the load of the power-supplying devices 104 increases, and their output power exits its original state of not exceeding the “maximum label power” to exceed the “maximum label power”.

If the output power increases continuously and reaches the “safety limitation power,” the power-supplying devices 104 will compulsorily enter a protection procedure (for example, entering a constant current mode, a hiccup mode, or a shutdown mode) or an intrinsic protection mechanism of other power-supplying devices 104 will start.

In particular, if the output power increases and exceeds the “maximum label power,” but does not exceed the “safety limitation power,” that is, an output power within an “over-subscription zone,” the power management controller 106 will control the at least one power-consuming device 102 to lower the power consumption thereof so as to restore the output power to below the maximum label value as soon as possible.

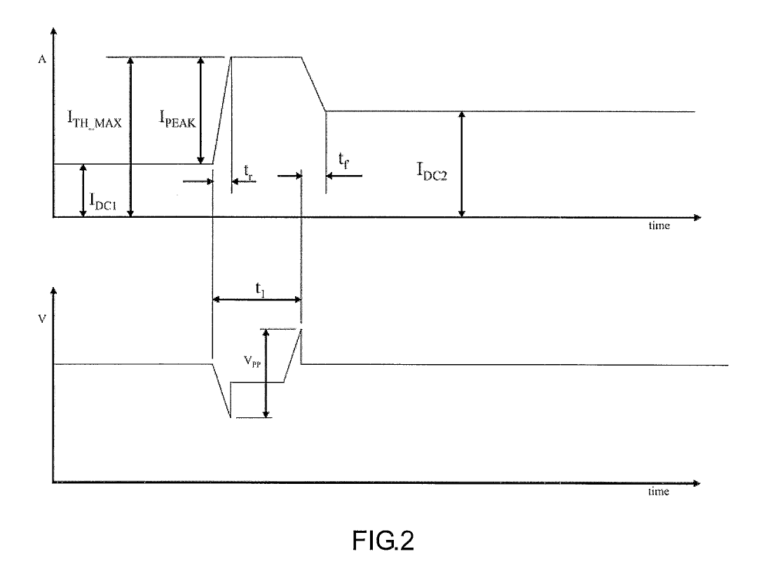

FIG. 2 and Table 2 disclose an example of an power-supplying devices 104 (A, B or C) whose output power enters “over-subscription zone.” In this embodiment, the output detector M of the power-supplying device 104 detects output current A and output voltage V of the power-supplying device 104 and then calculates the output power, using the product of output current A and output voltage V.

In practice, output voltage V usually has a variation not larger than ±3% (indicated by VPP of the waveform of output voltage V in FIG. 2). Therefore, it is feasible to treat output voltage V as a constant value (such as 12.2V). Hence, the output current A detected by the output detector M can be regarded as the sole index to the output power for determining whether the output power exceeds the “maximum label power” shown in Table 1 and has entered the “over-subscription zone.” Table 2 only enumerates related values of output current A in FIG. 2, wherein tr denotes the point in time when the output power enters the “over-subscription zone,” and tf denotes the point in time when the output power exits the “over-subscription zone.”

TABLE 2

Power-supplying device

| | Type A | Type B | Type C |
|---|---|---|---|
| t1 | 1 sec | 1 sec | 1 sec |
| tr | 76 μsec | 62 μsec | 46 μsec |
| tf | 38 μsec | 30 μsec | 22 μsec |
| IDC1 | 56 A | 47 A | 34 A |
| IDC2 | 75 A | 63 A | 46 A |
| IPEAK | 38 A | 31 A | 23 A |
| ITH_MAX | 94 A | 78 A | 57 A |

### Throttle Signal

In this embodiment, the power-supplying device 104 and the power management controller 106 are connected by specific signal pins for transmitting a throttle signal. Hence, once the output power reaches the “over-subscription zone,” the power-supplying device 104 will use the throttle signal to inform the power management controller 106, such that the power management controller 106 can start a control procedure for lowering the power consumption of the at least a power-consuming device 102. Preferably, the throttle signal comes in the form of a logic signal. That is, the power-supplying device 104 changes the output level and thereby transmits the throttle signal to the power management controller 106.

For example, in a normal situation (i.e., when the output power is less than the “maximum label power”), the power-supplying device 104 supplies a high power level to the power management controller 106. The high power level is set to an operation voltage (such as 3.3V or 5V) for use with the computer system 10. Once the output power reaches the “over-subscription zone,” the power-supplying device 104 will supply a low power level (such as 0V) to the power management controller 106. After detecting the low-level throttle signal, the power management controller 106 performs the control procedure for lowering the power consumption of the at least a power-consuming device 102.

It is feasible that other signal pins are connected between the power-supplying device 104 and the power management controller 106 and adapted to serve another purpose, and thus the present invention is not limited thereto.

The power management controller 106 can lower the power consumption of the at least one power-consuming device 102 by any conventional means, and thus the present invention is not limited thereto. However, to reduce the chance that the power-supplying device 104 gets damaged by operating in the “over-subscription zone” for an overly long period of time, the power management controller 106 controllably lowers the output power to below “maximum label power” in a short period of time, preferably between 0.9 second and 1.1 seconds. In the example illustrated with FIG. 2 and Table 2, when put under the control of the power management controller 106, the power-supplying device 104 does not spend a time period t1 of longer than one second in the “over-subscription zone”. By contrast, the manufacturers of the power-supplying device 104 should attempt to ensure that the power-supplying device 104 will not get damaged and break down during the allowable short period t1 in the “over-subscription zone”.

### Disable Throttle Signal

Under the control of the power management controller 106, if the power consumption of the at least a power-consuming device 102 is successfully lowered to thereby decrease the output power from an “over-subscription zone” to below the “maximum label power” so as to attain a reference value, the power-supplying device 104 will restore the low voltage level (0V) to the initial high voltage level (3.3V or 5V), thereby disabling the throttle signal. After detecting the initial high voltage level, the power management controller 106 stops the procedure of lowering the power consumption. To avoid compromising the efficiency of operation of the computer system 10, the reference value is set to 90% to 96% of the “maximum label power,” preferably about 95% of the “maximum label power.”

The method of lowering the power consumption of the at least a power-consuming device 102 by the power management controller 106 is well known among persons skilled in the art and thus is not reiterated herein for the sake of brevity. In addition to the throttle signal related to the “over-subscription zone,” the power management controller 106 may give consideration to measurement parameters or signals provided by other components before determining the best way to lower the power consumption of the at least one power-consuming device 102 and identifying the criteria for stopping the procedure of lowering the power consumption of the at least one power-consuming device 102.

### Second Embodiment

### Output Current

In this embodiment, as shown in Table 1, an output current of the power-supplying devices 104 (A, B, C) is defined with a “maximum label current” and a “safety limitation current” whose definitions are similar to those of the aforesaid “maximum label value” and “safety limitation value.” Hence, the output current of the power-supplying devices 104 (A, B, C) is always designed to feature an “over-subscription zone.”

Like the first embodiment, in this embodiment, if the output current increases continuously and reaches the “safety limitation current,” the power-supplying devices 104 will compulsorily enter a protection procedure, or an intrinsic protection mechanism of other said power-supplying devices 104 will start.

In particular, if the output current increases and exceeds the “maximum label current” but does not exceed the “safety limitation current,” that is, an output current within the “over-subscription zone,” the power management controller 106 will control the at least one power-consuming device 102 to lower its power consumption and thus lower its consumed current so as to restore the output current to below the maximum label value as soon as possible.

Unlike the first embodiment, this embodiment gives no consideration to the output power (i.e., the product of the output current and the output voltage). Hence, the output current waveform shown in the upper half of FIG. 2 and Table 2 can also provide an example for illustrating how the output current of the power-supplying devices 104 (A, B, C) enters the “over-subscription zone,” wherein tr denotes the point in time when the output current enters the “over-subscription zone,” and tf denotes the point in time when the output current exits the “over-subscription zone.” For other details, such as the details of the throttle signal, reference should be made to the description of the first embodiment.

### Third Embodiment

### Output Voltage

In this embodiment, as shown in Table 1, an output voltage of the power-supplying devices 104 (A, B, C) is defined with a “safety limitation voltage” whose definition is similar to that of the aforesaid “safety limitation value.” Although Table 1 does not define a “maximum label voltage,” it is feasible to treat the upper limit of the allowable small variation of a “label voltage” as the “maximum label voltage.” For example, the “maximum label voltage” can be defined as 103% or 105% of the “label voltage.” Accordingly, the output voltage of the power-supplying devices 104 (A, B, C) can also be designed to feature an “over-subscription zone.”

Like the first embodiment, in this embodiment, if the output voltage increases continuously and reaches the “safety limitation voltage,” the power-supplying devices 104 will compulsorily enter a protection procedure, or an intrinsic protection mechanism of other said power-supplying devices 104 will start.

In particular, if the output voltage increases and exceeds the “maximum label voltage” but does not exceed the “safety limitation voltage”, that is, the output voltage is within the “over-subscription zone,” the power management controller 106 will control the at least a power-consuming device 102 to lower its power consumption and thus lower its consumed voltage so as to restore the output voltage to below the maximum label value as soon as possible.

Unlike the first embodiment, this embodiment gives no consideration to the output power (i.e., the product of the output current and the output voltage). For other details, such as the details of the throttle signal, reference should be made to the description of the first embodiment and the second embodiment.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. A computer system, comprising:
a power-consuming device;
a power-supplying device that supplies power to the power-consuming device, wherein a metric of the power supplied by the power-supplying device has a maximum label value, a safety limitation value higher than the maximum label value, and an over-subscription zone between the maximum label value and the safety limitation value, and wherein the power-supplying device enters a protection procedure in response to the metric exceeding the safety limitation value; and
a power management controller, coupled to the power-supplying device and to the power-consuming device, that controls power consumption of the power-consuming device, wherein the power management controller lowers the power consumption of the power-consuming device in response to the metric of the power exceeding the maximum label value and entering the over-subscription zone.

2. The computer system of claim 1, wherein the power-supplying device transmits a throttle signal to the power management controller in response to the metric of the power entering the over-subscription zone.

3. The computer system of claim 2, wherein the power-supplying device transmits the throttle signal by changing a level of the throttle signal.

4. The computer system of claim 3, wherein the power-supplying device transmits the throttle signal by changing the level of the throttle signal from a high voltage level to a low voltage level.

5. The computer system of claim 1, wherein the power management controller controls power consumption of the power-consuming device, such that the metric of the power remains continuously in the over-subscription zone for no more than a predetermined time period.

6. The computer system of claim 5, wherein the predetermined time period is approximately 1 second.

7. The computer system of claim 1, wherein:
the metric of the power of the power-supplying device has a reference value lower than the maximum label value; and
the power management controller controls the power-consuming device to stop lowering the power consumption of the power-consuming device in response to the metric decreasing from the over-subscription zone to not higher than the reference value.

8. The computer system of claim 7, wherein the reference value is about 90% to 96% of the maximum label value.

9. The computer system of claim 1, wherein the protection procedure comprises entering one of a constant current mode, a hiccup mode, and a shutdown mode.

10. The computer system of claim 1, wherein the metric is output power.

11. The computer system of claim 1, wherein the metric is output voltage.

12. The computer system of claim 1, wherein the metric is output current.

13. A method of operating a computer system including a power-consuming device, a power-supplying device, and a power management controller, the method comprising:
the power-supplying device supplying power to the power-consuming device, wherein a metric of the power supplied by the power-supplying device has a maximum label value, a safety limitation value higher than the maximum label value, and an over-subscription zone between the maximum label value and the safety limitation value;
the power-supplying device entering a protection procedure in response to the metric exceeding the safety limitation value;
the power management controller controlling power consumption of the power-consuming device, wherein the controlling includes the power management controller lowering the power consumption of the power-consuming device in response to the metric of the power exceeding the maximum label value and entering the over-subscription zone.

14. The method of claim 13, and further comprising the power-supplying device transmitting a throttle signal to the power management controller in response to the metric of the power entering the over-subscription zone.

15. The method of claim 14, wherein the transmitting includes the power-supplying device changing a level of the throttle signal from a high voltage level to a low voltage level.

16. The method of claim 13, wherein the controlling includes the power management controller controlling power consumption, such that the metric of the power remains continuously in the over-subscription zone for no more than a predetermined time period.

17. The computer system of claim 5, wherein the predetermined time period is approximately 1 second.

18. The method of claim 1, wherein:
the metric of the power of the power-supplying device has a reference value lower than the maximum label value; and
the controlling further includes the power management controller controlling the power-consuming device to stop lowering the power consumption of the power-consuming device in response to the metric decreasing from the over-subscription zone to not higher than the reference value.

19. The computer system of claim 19, wherein the reference value is about 90% to 96% of the maximum label value.

20. The computer system of claim 1, wherein the metric is one of a set including output power, output voltage, and output current.
